(19) United States
(12) Patent Application Publication
(10) Pub. No.: US 2002/0009699 A1
(43) Pub. Date: Jan. 24, 2002

(54) Data receiving device and image forming apparatus using same

(76) Inventors: Kenichi Hyodo, Toyokawa-Shi (JP); Nozomu Shiotsu, Okazaki-Shi (JP)

Correspondence Address: Barry E. Bretschneider, Morrison & Foerster LLP, Suite 5500, 2000 Pennsylvania Avenue, N.W., Washington, DC, 20006-1888, US

(21) Appl. No.: 09/844,667

(22) Filed: Apr. 30, 2001

(30) Foreign Application Priority Data
Apr. 28, 2000 (JP) 2000-130438
Aug. 10, 2000 (JP) 2000-242093

(51) Int. Cl. G09B 27/00

(52) U.S. Cl. 434/285

(57) ABSTRACT

The position of each pixel of an original image is corrected for projection in order to eliminate distortion in the projection image generated by the relationship between the projection image used to photograph the original image and the projection method used to project the original image in a planetarium. First, a density data table corresponding to each pixel position is prepared for every frame of the motion image data. Then, an image location table is generated to correlate the converted pixel position converted to eliminate distortion in the projection image to the pixel position prior to conversion. Then, the original density data at each converted pixel position are determined from the density data table with reference to the pixel position before conversion in the image location table. In this way a distortion free projection image is obtained by converting and projecting the pixel positions of the motion image.

The present application claims priority to Japanese Patent Application No. 2000-130438 filed on Apr. 28, 2000, and Japanese Patent Application No. 2000-242093 filed on Aug. 10, 2000, the entire contents of which are hereby incorporated by reference.

### BACKGROUND OF THE INVENTION

1. Field of the Invention

The present invention relates to a method and device for processing an image projected on a spherical screen, and relates to a planetarium using this device.

2. Description of the Related Art

The embodiments of the present invention are described with reference to FIG. 1. In addition to fixed-star projection device 1, and planet, satellite, celestial body projector 2, planetariums in recent years have begun using one or more video projector 3, panorama projector 4, fisheye lens projector 5 and the like in combination. In this way various performances and explanations become possible.

The video projector 3 projects a planar image photographed by a projection method y=ftanω by the identical projection method y=ftanω. In this method, y represents the image height, ω represents the field angle, and f represents the coefficient of proportionality. Even when the original image is projected on a flat screen by the video projector 3, there is not distortion in the projected image. However, when the image is projected an equal distance to a dome screen 6 having a spherical surface such that y=fω, the square original image is projected with the distortion indicated by the projection image 7 shown in FIG. 1.

The effect of the distortion on the image is relative small since the image is only projected to a small part of the dome screen 6. For this reason, the distortions heretofore has not been a problem.

On the other hand, when an image is projected over the entirety of the dome screen 6 for a performance or explanation, the square original image becomes greatly distorted and difficult to view as indicated in projection image 8 shown in FIG. 1. For this reason realism is lost and such a projection is unusable in a practical sense.

Such distortion originates in the difference between the projection method when photographing or preparing the original image and the projection method when projecting the image, or the relationship between the projection method when preparing the original image and the spherical dome screen 6.

### SUMMARY OF THE INVENTION

A main object of the present invention is to provide an image projection method and device for a planetarium capable of alleviating or eliminating the distortion of the projection image by changing and projecting the pixel position of the image in accordance with the cause of distortion.

These and other objects are attained by a planetarium comprising:

an input unit for sequentially inputting projection image data;

pixel position data generating means for converting the pixel position of image data input from the input unit and generating converted pixel position data so as to alleviate the distortion in the projection image produced by the relationship between the projection method when preparing the original image of image data input from the input unit and the projection method when projecting the original image;

projection image data generating means for generating image data for projection based on the image data input from the input unit and the converted pixel position data generated by the pixel position data generating means;

an output unit for outputting image data generated by the projection image data generating means; and

a video projector for projecting the image output from the output unit to the dome screen of the planetarium.

According to this construction, even when there is a relationship causing distortion in the projection image due to differences in the projection method used when preparing an original image and a projection method used when projecting this original image, each pixel position of the original image can be corrected to a position eliminating distortion in the projection image based on a constant correlation between the aforesaid relationship and the distortion in the projection image, thereby alleviating the distortion in the projection image by the degree of this correction. The method used to prepare the original image may be a method of photography using a camera or the like, or may be a method using a computer to generate the original image. Furthermore, the image need not be a still image, and may be a motion image which is very effective in performances. It is desirable that distortion in the projection image is alleviated to the point of elimination.

The present invention is not only applicable to projection onto the dome screen of a planetarium, but is also applicable to projection onto a spherical screen and curved screen installed at a facility other than a planetarium.

In these projection methods, each pixel position of the original image can be corrected and projected such that the image projected on the spherical surface screen is projected at a position reproducing the condition of the projected original image, and in this way the projection image is corrected for distortion so as to prevent the image from protruding out from a specific region of the spherical surface screen, or being reduced smaller than a specific region. A second aspect of the present invention is a video projection device comprising an image data input unit for sequentially inputting motion image data for projection, a pixel position data generating means for sequentially converting the pixel position of sequentially input motion image data and generating converted pixel position data so as to alleviate or eliminate the distortion in the projection image produced by the relationship between the projection method when photographing or preparing the input original image and the spherical screen used for projection, a projection image data generating means for sequentially generating projection image data after pixel position conversion of each frame from the input motion image data and the converted pixel position data generated by the pixel position data generating means, and an output unit for outputting projection image data in frame units generated sequentially by the projection image data generating means to a corresponding video projector.

According to this construction, in a planetarium, motion image data sequentially input from an image data input unit are sequentially output from an output unit to a corresponding video projector for projection. When the relationship between the projection method when photographing or preparing the input original image and the spherical screen used for projection produces distortion in the motion image data input by the pixel position data generating means, each pixel position of the original image is converted to a position which alleviates or eliminates the distortion in the projection image based on a constant correlation between the distortion of the projection image and the aforesaid relationship and converted pixel position data are sequentially generated. Since projection image data are sequentially generated and output for projection from the output unit after conversion of the pixel position for each frame from converted pixel position data continuously generated by the pixel position data generating means and motion image data input by the projection image data generating means, the distortion in the motion image can be alleviated or eliminated when the motion image is projected.

In this projection device, the projection image data generating means is provided with a density value data table for recording and updating each corresponding pixel position and its density value in frame units from the motion image data before conversion, and an image location table for recording and updating corresponding pre-conversion pixel position and post-conversion pixel position via the pixel position data generating means in frame units. Furthermore, a projection image data compiler may be provided to verify the corresponding original pixel position from the image location table for each converted pixel position, and reference and combine density values corresponding to the confirmed original pixel position, and sequentially generate, record, output and update projection image data after pixel position conversion in frame units. In this way, while preparing the density value tables corresponding to each pixel position in frame units from the motion image data and the image location table of the converted pixel position corresponding to the pre-conversion pixel position so as to alleviate or eliminate distortion in the projection image at each pixel position in frame units, high-speed processing is achieved without complex controls or calculation operation by simply filling the original density value from the density value table while referencing the corresponding pre-conversion pixel position for each converted pixel position obtained in frame units, such that projection image data corrected only for the pixel position are generated and projected so as to alleviate or eliminate distortion in the projection image having the same gradient and same number of pixels from the normal motion image data, and an image is projected which has alleviated distortion or is distortion free.

The invention itself, together with further objects and attendant advantages, will be best understood by reference to the following detailed description taken in conjunction with the accompanying drawings.

### BRIEF DESCRIPTION OF THE DRAWINGS

FIG. 1 is a perspective view showing the overall structure of a planetarium using embodiments of the video projection method and device of the present invention;

FIG. 2 illustrates a first embodiment of the invention projecting the corrected pixel position without distortion compared to projection of the uncorrected pixel position with distortion;

FIG. 3 is a perspective view schematically showing three-dimensional example of the sequence of pixel position correction in the present embodiment;

FIGS. 4(a)-4(c) illustrate the relationship of the original image pixel position before correction and the pixel position after correction;

FIG. 5 is a block diagram of the control circuit of the planetarium video projection device of the first embodiment;

FIG. 6 is a block diagram showing the signal processing table in the block diagram of FIG. 5;

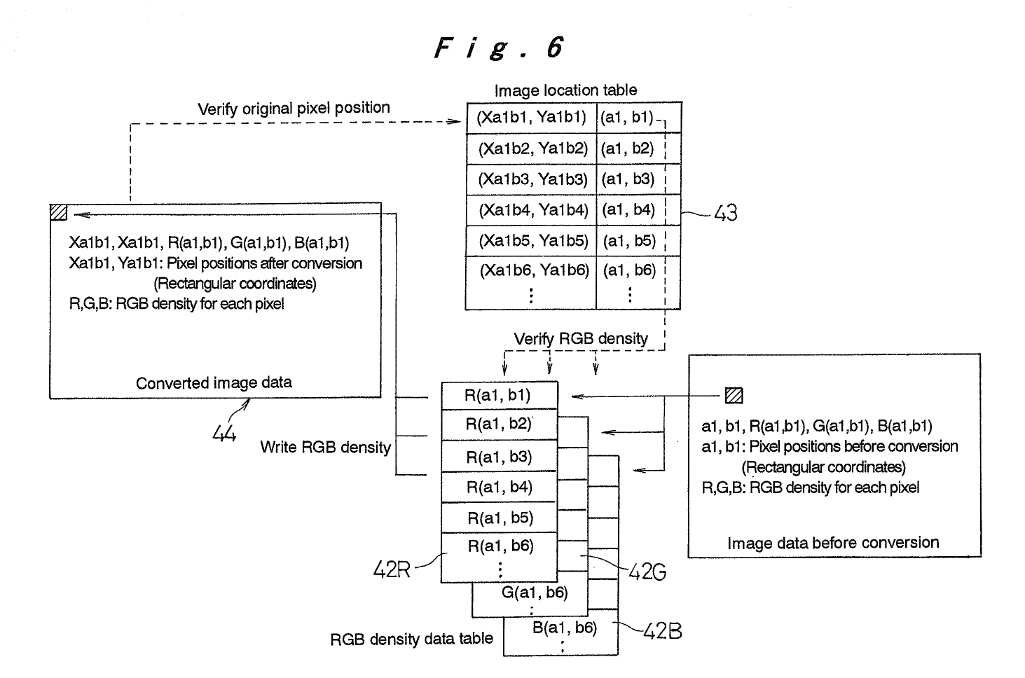

FIG. 7 is a bottom view showing the situation of projecting on part of a dome screen using a projection lens capable of projecting on the entire dome screen in a second embodiment of the invention;

FIG. 8 is a front view showing an original image of the projection image shown in FIG. 7; and

FIG. 9 is a perspective view schematically showing a three-dimensional example of the sequence of pixel position correction in the embodiment.

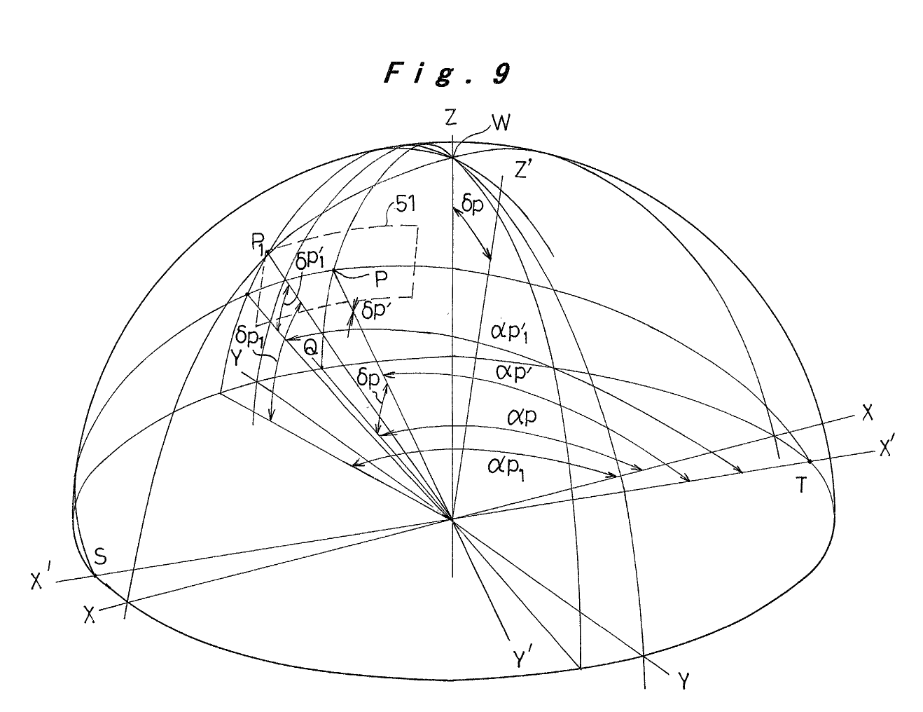

In the following description, like parts are designated by like reference numbers throughout the several drawings.

### DETAILED DESCRIPTION OF THE PREFERRED EMBODIMENTS

The embodiments of the present invention are described hereinafter with reference to the accompanying drawings to facilitate understanding of the invention.

First Embodiment

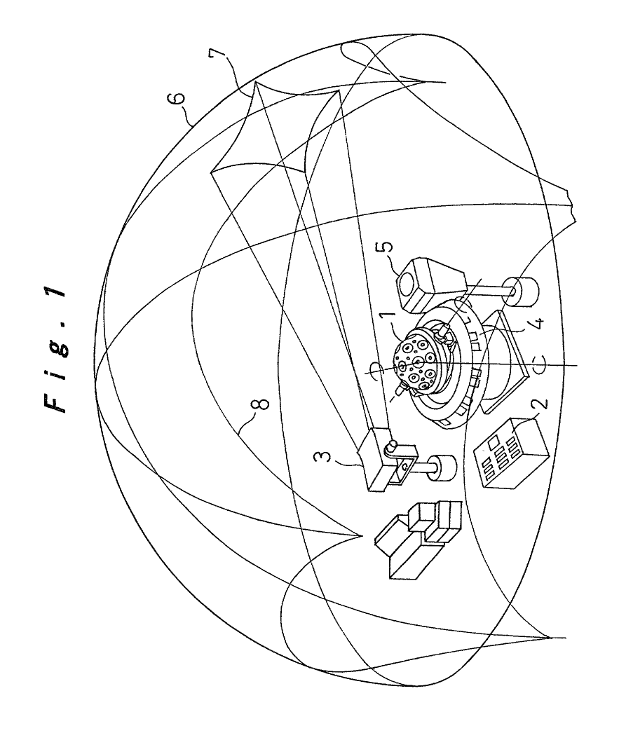

The first embodiment relates to a video projection device for a planetarium, and is an example of an application to a planetarium such as shown in FIG. 1 touched upon previously by aspects of the conventional art. However, the present invention is applicable not only to projection of a motion image on a dome screen in various types of planetarium facilities, but also is effective when applied to projection of still images on a spherical screen, and all such applications are within the category of the present invention.

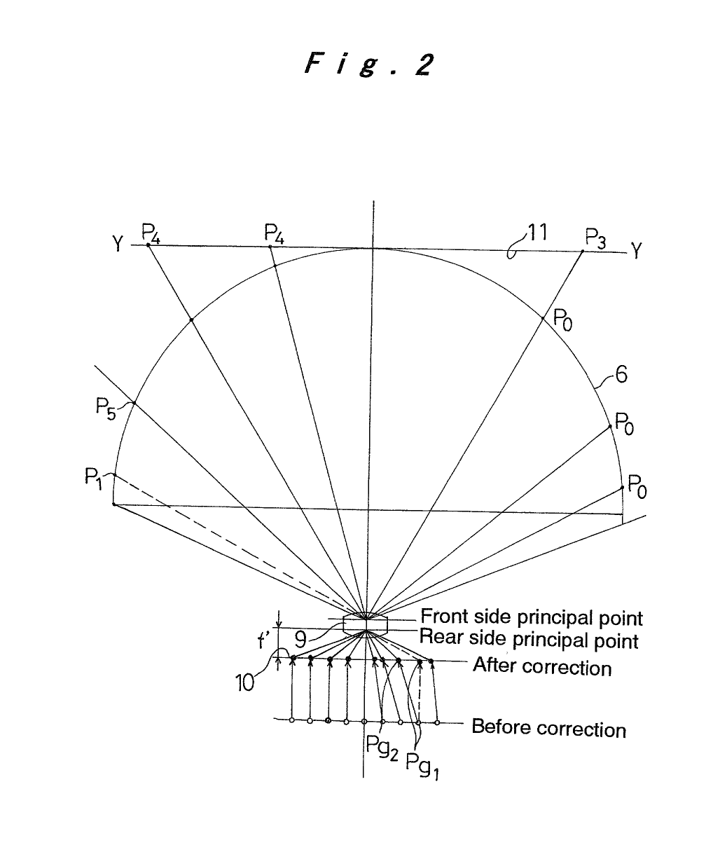

An original image which is the previously mentioned motion image is a flat image generally photographed or prepared by a projection method using y=tanω. This flat image becomes distorted when projected on a spherical dome screen at equal spacing projection y=tanω by a standard projection lens (refer to FIG. 2). FIG. 2 shows the principle of the distortion condition of the image. In FIG. 2, when projected on the flat screen 11, the equal-spaced pixel positions Pg1 in the Y-direction on the original image 10 do not generate distortion in the projection image when projected as points P3 at equal spacing in the Y-direction. In contrast, when projected on a spherical dome screen 6, the points are projected as point P0 at unequal spacing, and the projection image becomes distorted.

Since the first embodiment 1 eliminates distortion in the projection image generated by the relationship between the projection method used to photograph or prepare the original image 10 and the spherical dome screen 6 when projecting the original image 10 on a spherical dome screen 6, the original pixel position Pg1 is corrected to the pixel position Pg2 without distortion as shown on the right side of the original image 10, and the image is projected as the projection image shown in the left side of FIG. 2. The pre-correction pixel positions Pg1 have equal spacing as shown on the right side of the original image 10, and are corrected to pixel positions Pg2 having unequal spacing, and become equal-spaced points P5 when projected on the dome screen 6. Conversely, the pixel positions Pg2 become points P4 having equal spacing when projected on a flat screen 11. In this way even though a relationship exists between the projection method when photographing or preparing the original image 10 and the spherical dome screen 6 on which is projected to the motion image which generates distortion in the projection image as represented in the projection image on the right side and the original image on the left side in FIG. 2, each pixel position of the original image 10 can be corrected to a pixel position such that the projection image is without distortion based on a constant correlation between this relationship and the distortion in the projection image, and the distortion in the projection image can be alleviated or eliminated by the degree of this correction.

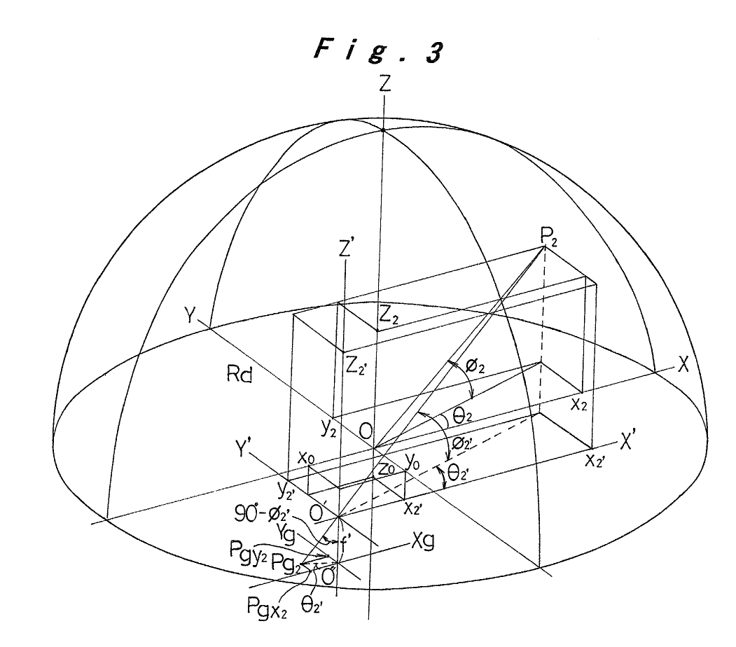

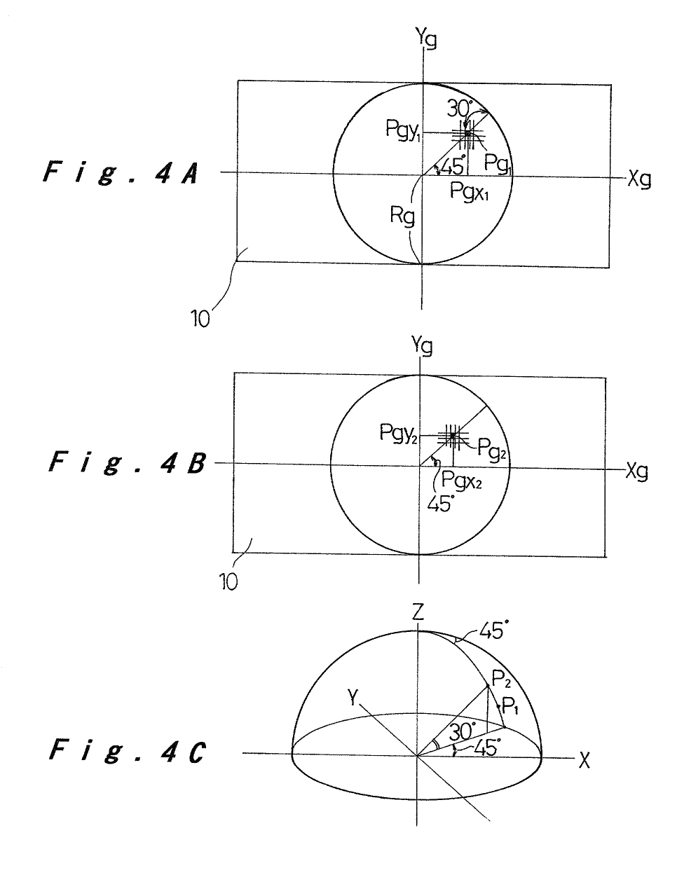

FIG. 3 illustrates this relationship three-dimensionally. FIG. 4(a) shows the original image 10 before correction and the pixel position Pg1, and FIG. 4(b) shows the corrected original image 10 and the pixel position Pg2. FIG. 4(c) shows projection point P1 of the pixel position Pg1 in the original image 10 before correction, and the ideal projection point P2 of the pixel position Pg1 to project the original image 10 without distortion.

The pixel Pg1 in original image 10 shown in FIG. 4(a) (, i.e., position (Pgx1, Pgy1) on the (Xg,Yg) coordinates in original image 10) is not corrected, and is projected to point P1 shown in FIGS. 2 and 4(c). However, pixel Pg1 in original image 10 is positioned at a location ⅓ of the radius R of the image circle toward the center Rg of the image circle. Accordingly, in order to project the image within the image circle of the original image 10 on the dome screen 6 without distortion, the pixel Pg1 must be projected on the projection point P2 shown in FIG. 4(c) at a height of 30° above the horizontal line of the dome screen 6. However, the projection point of the pixel Pg1 is P1 and is not at a height of 30° as indicated.

The pixel position on the original image 10 corresponding to the projection point P2 on the dome screen 6 is calculated based on the projection method of the projection lens 9 and the amount of offset of the principal point position. The calculated pixel position on the original image 10 is designated Pg2 (Pgx2,Pgy2). Finally, the pixel at point Pg1 on the original image 10 is converted by moving the position to point Pg2, i.e., when projected with this correction a distortion-free projection image is obtained.

The specific calculation method is described below.

(1) When the point (height of 30° from horizontal line of the dome) at which the pixel Pg1 on the original image 10 before correction is projected without distortion is designated P2 (θ2,φ2), the point P2 is determined by the following method.

Horizontal angle

$$Θ2 = tan ( \frac{Pgy1}{Pgx1} )$$

Height from Horizontal line

φ2=(Rg-Pg1 point distance from center of original image)×(division angle in height direction)

Where the division angle in the height direction is 90°/Rg (number of pixels), division angle in the azimuth direction is 360°/(circumference of image circle (number of pixels)), and the distance of point Pg1 from the center of the original image is

$$\sqrt{{Pgx1}^{2} + {Pgy1}^{2}} .$$

(2) The angle of point P2 (θ2′,φ2′) in the coordinate system having a principal point on the anterior side of the projection lens 9 as the origin point (i.e., a coordinate system having o′ as the origin point) is determined by the equations below. The amount of offset of the anterior principal point position from the center (O) of the dome screen 6 is designated X0, Y0, Z0, and the radius of the dome screen 6 is designated Rd.

X2=Rd•cosφ2•cosθ2

y2=Rd•cosφ2•cosθ2

Z2=Rd•sinφ2

X2′=X2-X0

Y2′=Y2-Y0

Z2′=Z2-Z0

$${Θ}^{′} 2 = {cos}^{- 1} ( \frac{{X2}^{′}}{\sqrt{{X2}^{′ 2} + {Y2}^{′ 2}}} )$$

$${φ}^{″} 2 = {sin}^{- 1} ( \frac{{Z2}^{′}}{\sqrt{{X2}^{′ 2} + {Y2}^{′ 2} + {Z2}^{′ 2}}} )$$

(3) Then, the original image coordinate Pg2 (Pgx2,Pgy2) in the coordinate system having the point P2 at the center of the original image 10 (i.e., a coordinate system having O″ as the origin point) is determined by the equations below.

$$r2 - {f}^{′} \cdot ( \frac{π}{2} - φ {2}^{′} )$$

Pgx2=r2•cosθ2′

Pgy2=r2•sinθ2′

Where r2 represents the distance from the center of the original image 10, the projection method is equal-spaced projection (y=fω), and f′ represents the distance from the posterior side principal point of the projection lens 9 to the original image 10. When f′≈f (focal length of the projection lens 9), approximation is possible.

(4) A distortion-free projection image is obtained by moving the pixel of Pg1 to the new position Pg2.

(5) An identical process is repeated for the number of divisions of the dome screen 6.

(6) A method is described in (1)˜(5) to initially extract a single optional pixel in the original image 10 before correction, and this pixel is moved to a new pixel position so as to project this pixel on the dome position without distortion.

Another embodiment, however, uses the method described below. First, the entirety of the dome screen 6 is divided at equal angles (the number of divisions at this time is determined based on the resolution of the original image 10 and the image circle radius Rg), and whether or not a single division (P2) extracted from the divided dome divisions is at position (Pg2) on the original image 10 is calculated by the offset position and the optical system (same method as (2) and (3)).

Then, The pixel (Pg1) to be projected to the specific division on the divided dome screen 6 can be readily ascertained under the rule that the “equal-spaced original image may be projected at equal angles on the dome screen 6 so as to project a distortion-free image.”If this pixel is moved to a previously determined position (Pg2), a similar effect is obtained.

In this instance, the point (P1) at which the pre-correction pixel (Pg1) is projected need not be calculated.

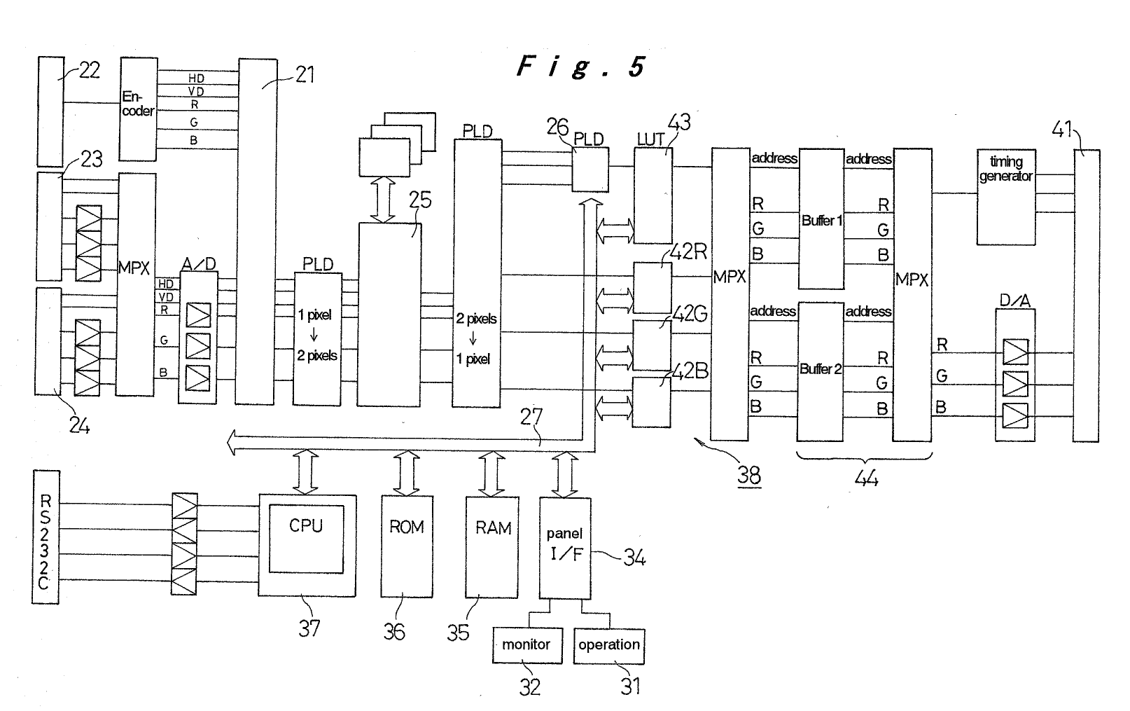

In the first embodiment, the processes described above are executed by the controller shown in FIG. 5. The input unit 21 of the controller is provided with a motion image input unit 22 for inputting motion image data, and computer image input units 23 and 24 to receive computer format motion image data from a personal computer and the like. The input image is invariably a color image, such that the input image data contain image signals of the three colors RGB colors. The input unit 21 converts a single pixel of the input image data to two pixels, and the resolution of these pixels is converted to a specific resolution by a resolution converter 25. After resolution conversion, the image data are converted from two pixels to one pixel, so as to return to the same number of pixels and same gradient as the input image data.

The image data returned to the same gradient and number of pixels are transmitted directly, or after suitable frequency conversion as necessary, through a pixel counter 26 and internal bus 27 to various related units.

The internal bus 27 is mutually connected to a panel interface 34 to which are connected the pixel counter 26 and operation unit 31 and monitor 32, a RAM 35, ROM 36, CPU 37, and projection image data generator 38. The CPU 37 functions as a pixel position data generator for sequentially converting the pixel position of the sequentially input motion image data and generating converted pixel position data so as to alleviate or eliminate distortion in the projection image generated by the relationship between the projection method used to photograph or prepare the original image related to the input motion image and the spherical surface dome screen 6 used for projection. A projection image data generator 38 sequentially generates projection image data after pixel position conversion for each frame from the input motion image data and converted pixel position data generated by the CPU 37. The projection image data sequentially generated by the projection image data generator 38 are through an output unit 41 to a corresponding video projector for projection.

In this way, even when a relationship exists between the projection method used when preparing the original image 10 related to the motion image data and the spherical dome screen 6 such that distortion is generated in the projection image when the motion image data sequentially input from the input unit 21 are sequentially output from the output unit 41 to the corresponding video projector 3 for projection, each pixel position of the original image 10 is converted to a position which alleviates the distortion in the projection image by sequentially generating converted pixel position data using a conversion method or a table based on a constant correlation between this relationship and the distortion in the projection image. Then, distortion is alleviated or eliminated from the motion image since the projection image data generator 38 sequentially generates projection image data after pixel position conversion of each frame from the input motion image data and the converted pixel image position data generated by the CPU 37 and these projection image data are output from the output unit 41 for projection.

In particular, the projection image data generator 38 is provided with density data tables 42R, 42B, 42G corresponding to each pixel position and its density value in frame units from the pre-conversion motion image data, and an image location table 43 corresponding to the pre-conversion pixel position and post-conversion pixel position in frame units, and a projection image data compiler is provided to verify the original pixel position corresponding to the converted pixel position from the image location table 43, reference each RGB density value corresponding to the verified original pixel position from the density data tables 42R, 42G, 42B to generate, record, output and update image data after pixel position conversion in frame units corresponding to the converted pixel position.

In this way, while preparing the density value tables 42R, 42G, 42B corresponding to each pixel position in frame units from the motion image data and the image location table 43 of the converted pixel position corresponding to the pre-conversion pixel position converted so as to alleviate or eliminate distortion in the projection image at each pixel position in frame units, high-speed processing is achieved without complex controls or calculation operation by simply filling the original density value from the density value table while referencing the corresponding pre-conversion pixel position in the image location table 43 for each converted pixel position obtained in frame units, such that projection image data corrected only for the pixel position are generated and projected so as to alleviate or eliminate distortion in the projection image having the same gradient and same number of pixels from the normal motion image data, and an image is projected which has alleviated distortion or is distortion free.

Ideally, sub-pixel processing executed when referencing the RGB value of each pixel. This sub-pixel processing determines the average value of pixels adjacent to a reference pixel position, e.g., considering the distance from four RGB values, and this average value is used as the RGB value of the pixel after conversion, and is used to control excessive brightness of a single pixel. Furthermore, ideally, post-conversion image data is filtered. This filtering is a process to eliminate jaggys using a gradual bi-linear or tri-linear method, and removes the jaggedness in the converted image.

Operations performed by the CPU 37 are ideally executed in real time. Real time operation will allow the converted pixel position table to be updated for each frame if, for example, the future performance of the CPU is improved 200 times or more over current performance. In this instance, the process need not stop at simple correction inasmuch as various projection image effects can be obtained including zooming and wiping. Furthermore, projection image feeding and cutting can be performed by providing an RGB value conversion table in addition to the image location table 43.

Although the planetarium video projection method and device described above performs correction to alleviate or eliminate distortion in a projection image when such distortion is generated by the relationship between the projection method used to photograph or prepare an original image 10 and the spherical surface dome screen 6, the present invention is not limited to elimination of this distortion inasmuch as it also eliminates distortion in a projection image generated by the differences in the projection method used to photograph or prepare an original image 10 and the projection method used to project the original image, so as to correct each pixel position or the original image for projection. In this way, when a relationship exists which generates distortion in a projection image due to the differences in the projection method used to photograph or prepare an original image 10 and the projection method used to project the original image, each pixel position of the original image can be corrected to a position which eliminates distortion in the projection image based on a constant correlation between this relationship and the distortion in the projection image, such that distortion in the projection image can be alleviated or eliminated by the degree of this correction.

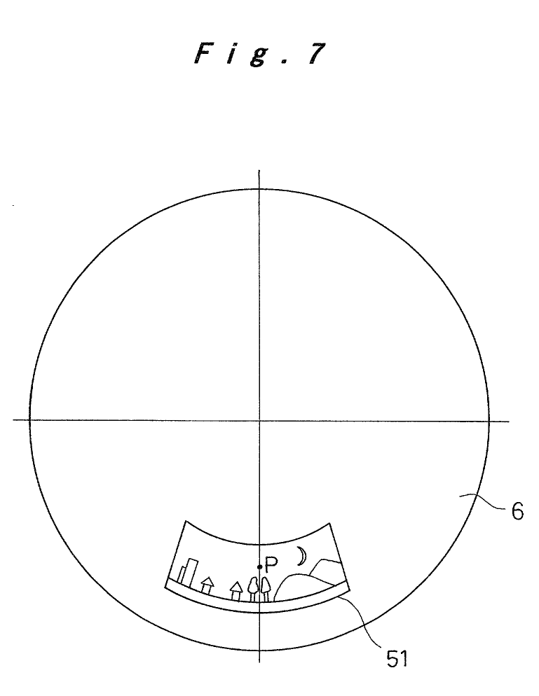

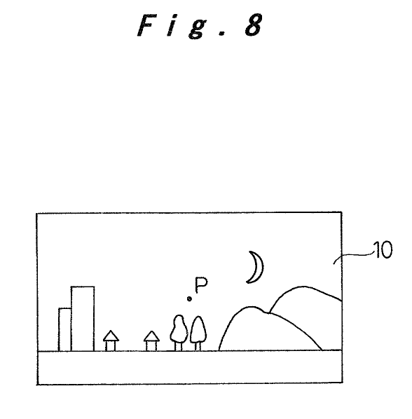

In the aforesaid projection method, each pixel position of the original image 10 can be corrected for projection such that the projection image projected on the spherical dome screen 6 shown in FIG. 7 can be projected at a position reproducing the projection condition of the original image 10 shown in FIG. 8. This correction prevents the projection image from protruding from a specific region and being smaller than a specific region of the spherical dome screen 6 due to the distortion correction.

Second Embodiment

The second embodiment is an example of a normal motion image photographed using a y=ftanω projection method of a photographic lens as shown in FIG. 8 projected on part of a dome screen 6 using a projection lens capable of projection to the entire dome screen 6 using an equal-spaced projection method of y=fω. The dome radius is designated R, the coordinate system having the dome bottom as the XY coordinate plane is designated [X,Y,Z], the dome zenith W passes through point P, the point of intersection with the XY coordinate plane is designated Q, the coordinate system wherein a plane including the line (S,P,T) passing through the center of the projection image 51 is designated the X′Y′ coordinate plane [X′,Y′], the desired field angle (field angle of the original image) is a vertical field angle of a° and horizontal field angle of b°, the original image center P is designated [αp,δp] in the [X,Y,Z] coordinate system and is designated [αp′,δp′] in the [X′,Y′,Z′] coordinate system, an optional point P1 on the original image 10 is designated [αp1,δp1] in the [X,Y,Z] coordinate system and is designated [αp1′,δp1′] in the [X′,Y′,Z′] coordinate system.

The division angle for correction is determined by the field angle of the original image 10.

Vertical direction field angle is the (vertical field angle a°)/(number of vertical pixels).

Horizontal direction field angle is the (horizontal field angle b°)/(number of horizontal pixels).

When the number of pixels of the original image 10 is represented as a position passing through the center of the original image in the [X′,Y′,Z′] coordinate system, the original image center P becomes [αp′,δp′], αp′=90°, δp′=0°, and the optional point P1 on the original image 10 becomes [αp1′, δp1′].

$$α {p1}^{′} = α {p}^{′} + \frac{a}{2}$$

$$δ {p1}^{′} = δ {p}^{′} + \frac{b}{2}$$

The rotation angle of the coordinate system is determined such that the center point P of the original image 10 approaches the desired projection point [αp1,δp1] in the dome coordinate [X,Y,Z].

Therefore, the coordinate system is rotated such that the X′ axis is rotated (δp) in a clockwise direction to the center, the Z′ axis is rotated (90°-αp) in a counterclockwise direction to the center, and finally point P1 [αp1, δp1] is determined as coordinate [αp1, δp1] in the dome coordinate system [X,Y,Z].

First, the polar coordinates are converted to orthogonal coordinates as shown below.

Xp1′=R•cosδp1•cosαp1

Yp1′=R•cosδp1•sinαp1

Zp1′=R•sinδp1

Next, the X′ axis is rotated only a rotation amount (δp) previously determined in the clockwise direction to the center.

Xp1″=Xp1′

Yp1″=Yp1′cos (-δp)+Zp1′sin (-δp)

Zp1″=Yp1′sin (-δp)+Zp1′cos (-δp)

The Z′ axis is rotated only a rotation amount (90°-αp) previously determined in the counterclockwise direction to the center as described below.

Xp1′″=Xp1″cos (90°-αp)+Yp1″sin (90°-αp)

Yp1′″=Xp1″sin (90°-αp)+Yp1″cos (90°-αp)

Zp1′″=Zp1′

Finally, the orthogonal coordinates are converted to polar coordinates as shown below.

$$α p1 = {cos}^{- 1} ( \frac{{Xp1}^{″}}{\sqrt{{Xp1}^{′′′ 2} + {Yp1}^{′′′ 2}}} )$$

$$δ p1 = {sin}^{- 1} ( \frac{{Zp1}^{′′′}}{\sqrt{{Xp1}^{′′′ 2} + {Yp1}^{′′′ 2} + {Zp1}^{′′′ 2}}} )$$

These coordinate points [αp1, δp1] are such that [αp1, δp1]=[θ1, φ1], and the required correction ends when the processes (1) and (2) identical to those of the first embodiment are performed for each pixel of the entire original image 10.

Although the present invention has been fully described by way of examples with reference to the accompanying drawings, it is to be noted that various changes and modifications will be apparent to those skilled in the art. Therefore, unless otherwise such changes and modifications depart from the scope of the present invention, they should be construed as being included therein.

What is claimed is:

1. A planetarium, comprising:
an input unit for sequentially inputting image data of images to be projected;
a pixel position data generator for generating pixel position data by converting pixel positions of the image data input from said input unit such as to alleviate distortion in a projected image resulting from a correlation between a projection method used for preparing an original image of which image data is input from said input unit and a projection method for projecting said original image;
a projection image data generator for generating image data of images to be projected based on the image data input from said input unit and the pixel position data generated by said pixel position data generator;
an output unit for outputting the image data generated by the projection image data generator; and
a video projector for projecting the images based on the image data output from said output unit onto a dome screen of the planetarium.

2. The planetarium according to claim 1, wherein said image to be projected is a motion picture.

3. The planetarium according to claim 1, wherein said pixel position data generator includes a look-up table containing original pixel positions before conversion and pixel positions after conversion, respectively corresponding to the original pixel positions before conversion.

4. An image processing device for processing images to be projected in a planetarium, comprising:
an input unit for sequentially inputting image data of images to be projected;
a pixel position data generator for generating pixel position data by converting pixel positions of the image data input from said input unit such as to alleviate distortion in a projected image resulting from a correlation between a projection method used for preparing an original image of which image data is input from said input unit and a projection method for projecting said original image;
a projection image data generator for generating image data of images to be projected based on the image data input from said input unit and the pixel position data generated by said pixel position data generator; and
an output unit for outputting image data generated by the projection image data generator to a video projector.

5. The image processing device according to claim 4, wherein said image to be projected is a motion picture.

6. The image processing device according to claim 4, wherein said pixel position data generator includes a look-up table containing original pixel positions before conversion and pixel positions after conversion, respectively corresponding to the original pixel positions before conversion.

7. An image processing device for processing images to be projected onto a curved screen, comprising:
an input unit for sequentially inputting image data of images to be projected;
a pixel position data generator for generating pixel position data by converting pixel positions of the image data input from said input unit such as to alleviate distortion in a projected image resulting from a correlation between a projection method used for preparing an original image of which image data is input from said input unit and a projection method for projecting said original image;
a projection image data generator for generating image data of images to be projected based on the image data input from said input unit and the pixel position data generated by said pixel position data generator; and
an output unit for outputting image data generated by the projection image data generator to a video projector.

8. The image processing device according to claim 7, wherein said projection image data generator comprises:
a first table for storing density values corresponding to each of pixel positions of image data before conversion;
a second table for storing original pixel positions before conversion and pixel positions after conversion by said image pixel data generator, respectively corresponding to the original pixel positions before conversion; and
a unit for generating density values at each of the converted pixel positions by reference to said first table and said second table.

9. The image processing device according to claim 7, wherein said image to be projected is a motion picture.

10. The image processing device according to claim 7, wherein said curved screen is spherical.

11. A video projection method in a planetarium, comprising the steps of:
correcting each of pixel positions of an original image for alleviating or eliminating distortion in a projected image resulting from a difference between a projection method used for photographing or preparing the original image and a projection method for projecting said original image; and
projecting a corrected image onto a dome screen by a video projector.

12. A video projection method for projecting an image onto a curved screen, comprising the steps of:
correcting each of pixel positions of an original image for alleviating or eliminating distortion generated in a projected image when projecting the original image onto the curved screen, said distortion resulting from a correlation between a projection method used for photographing or preparing the original image and the curved screen; and
projecting a corrected image onto a curved screen by a video projector.

13. The video projection method according to claim 12, wherein each of the pixel positions of the original image is corrected so that an image is projected on the curved screen at a position where a situation in which the original image has been photographed is reproduced.
